(19) United States
(12) Patent Application Publication
(10) Pub. No.: US 2012/0051602 A1
(43) Pub. Date: Mar. 1, 2012

(54) IMAGING A PRINT ABBERATION

(76) Inventors: Guy de W.B. Adams, Stroud (GB); Laurence M. Hubby, JR., Palo Alto, CA (US)

(21) Appl. No.: 13/318,693

(22) PCT Filed: May 21, 2009
(86) PCT No.: PCT/US09/44777

§ 371 Date: Nov. 3, 2011

(51) Int. Cl. G06K 9/00

(52) U.S. Cl. 382/112

(57) ABSTRACT

A technique includes imaging an aberration in print formed on a paper by a printer that has an associated minimum addressable mark size. The aberration has a size less than the minimum addressable mark size, and the imaging includes routing an image of the aberration through a symmetrical optical relay path to form an image on an imager.

### BACKGROUND

The invention generally relates to imaging a print aberration.

A particular document (a package label, a ticket, etc.) has conventionally been authenticated by scanning a code or pattern that is printed on the document and then comparing the scanned code or pattern with a reference. This type of authentication scheme may be subject to forgery, however, in that a relatively inexpensive copier or printer may be used to reproduce a counterfeit version of the code or pattern.

Another type of authentication scheme may use codes or patterns that have resolutions that are small enough to not be easily reproduced by inexpensive copiers and printers. However, a challenge with this alternative authentication scheme is that scanning equipment with a resolution sufficient to scan these codes or patterns typically is relatively expensive, as well as not being portable, thereby inhibiting the widespread use of this latter type of authentication scheme.

Other types of authentication schemes may use forensic/specialist/coded inks However, these schemes typically add cost and complexity, in particular to the printing process.

### BRIEF DESCRIPTION OF THE DRAWINGS

FIG. 1 is an illustration of printed matter resulting from the printing of a dot in an inkjet printing process according to an embodiment of the invention.

FIG. 2 is a schematic diagram of an optical system used to image a security mark according to an embodiment of the invention.

FIG. 3 is a flow diagram depicting a technique to image a security mark according to an embodiment of the invention.

FIG. 4 is an exemplary modulus of an optical transfer function versus spatial frequency according to embodiment of the invention.

FIG. 5 is a perspective view of a handheld security mark reader according to embodiment of the invention.

FIG. 6 is a schematic diagram of a printer which has a security mark reader according to embodiment of the invention.

### DETAILED DESCRIPTION

In accordance with embodiments of the invention, which are described herein, an authentication scheme relies on random microscopic variations that are naturally part of the printing process. In this context, “microscopic” means variations that are less than approximately 10 microns. Due to the randomness of these variations, when a printer, such as an inkjet printer, produces a printed output (herein called “printed matter”) in one instance, the printed matter contains microscopic variations, which are unique to this instance. These microscopic variations are typically not reproducible by the printer, even if the same nominal pattern is printed again by the same printer. More specifically, at a microscopic level, the printed matter that results from a printer printing a particular nominal pattern is unique and may be quite difficult to reproduce, even if the same print head, printer, swath, paper, etc., is used to reprint the pattern.

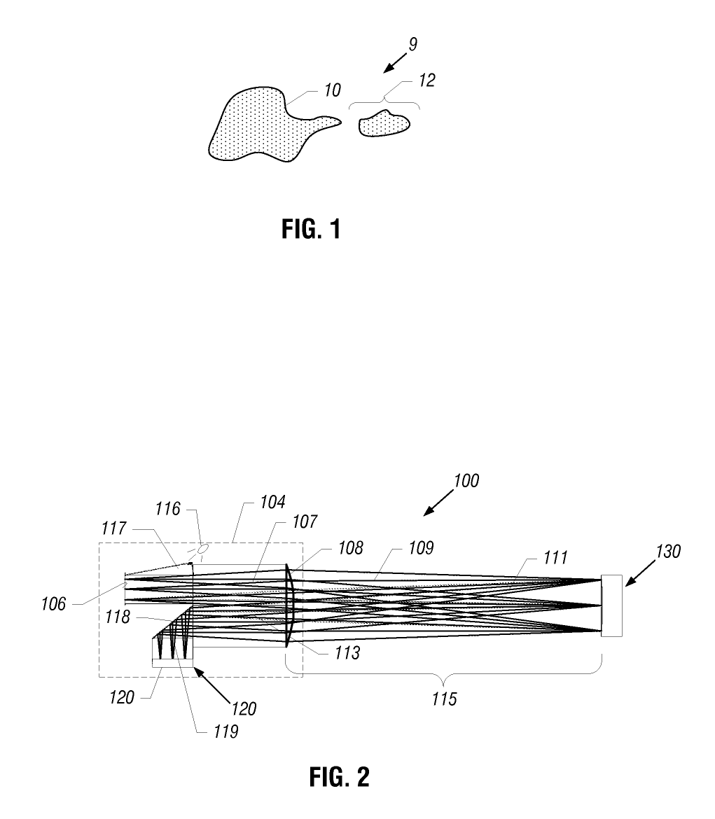

The microscopic variations in the printed matter are attributable to various uncontrolled random aspects of the printing process. Referring to FIG. 1, as a more specific example, for the exemplary case of an inkjet printer, for example, the printer may print a “dot” 9 on paper. Although to the human eye, the dot may appear to be round, each dot, at a microscopic level, contains a main, essentially round lobe 10 with microscopic local variations in the diameter and an associated tail 12, which, if present, may be attached, separate and possibly formed from multiple segments. The exact shape and placement of the tail 12 if present are examples of characteristics that are due to the random and uncontrolled aspects of the printing process, such as the velocity of the ink that leaves the nozzle, variations in the gap between the printing nozzle and the paper, the speed of the printer head, the speed of the printer paper, the surface texture of the paper, etc.

It is noted that although a “dot” formed from an inkjet printing process is illustrated for purposes of example in FIG. 1, microscopic aberrations are present in the printed matter that is formed in other printing processes. For example, the “dot” that is produced by a laser printing process may exhibit multiple satellites, the Indigo liquid electrophotographic (LEP) printing process may exhibit small variations in the diameter of the main lobe, etc.

Additionally, it is noted that microscopic aberrations are not limited to monochrome output. For example, microscopic spatial aberrations in color may exist in the same way as aberrations exist in a monochrome printing process. Furthermore, in a cyan magenta yellow (CMY) printing process, there may be microscopic variations in the registration or alignment of the color planes.

Because the above-described microscopic aberrations (regardless of the printing process) are typically less than ten microns in size, the aberrations are not possible to copy using normal printing or copying techniques, as the aberrations are significantly smaller than the minimum addressable mark sizes (the minimum addressable “dot size” of an inkjet printer, for example) of relatively inexpensive copiers and printers. As a result, the microscopic aberrations are not easily duplicated, and as such, the presence of these aberrations may be used for purposes of uniquely identifying a document, such as a label, a package, a ticket, etc.

In accordance with embodiments of the invention systems and techniques are described herein for purposes of scanning, or imaging, a security mark in sufficient detail such that the random microscopic features (features less than or equal to about 10 microns, for example) of the security mark are imaged. These imaged microscopic features may be analyzed for such purposes as authenticating a particular document that accompanies the security mark, such as authenticating a document on which the security mark is printed, for example.

Because conventional scanners that have the requisite resolution to scan the microscopic aberrations are relatively expensive, cost may be a barrier in imaging microscopic aberrations of a security mark. However, in accordance with embodiments of the invention, which are described herein, a security mark reader that is relatively inexpensive and has features that minimize the occurrence of user-introduced errors, may be used to image, or capture, the microscopic aberrations. As described below, in accordance with some embodiments of the invention, the security mark reader may be a handheld device.

Scanning microscopic aberrations in a security mark with a handheld device may encounter several technical challenges. In this manner, the field of view (FOV) and focal point of the handheld device may be somewhat uncontrolled due to these parameters being functions of how the user positions the scanner relative to the document being scanned, thereby placing performance constraints on the optics that are used to image the security mark. Furthermore, motion of the handheld device may introduce motion blur. Other potential limiting constraints are the cost and complexity of the handheld device.

Referring to FIG. 2, in accordance with embodiments of the invention, a relatively low cost handheld security mark reader has a design with a FOV and set focal point, which are largely unaffected by the coordination skills of the user. The handheld security mark reader has an optical system 100, which contains a symmetrical optical relay, such as a Dyson relay (as depicted in FIG. 2), to form an image of a scanned security mark on a complimentary metal oxide semiconductor (CMOS) imager, or sensor 120, for purposes of electrically capturing the image. The feature sizes that are imaged by the optical system 100 may be less than ten microns. The CMOS sensor 120 may have a resolution on the same order. Therefore, in accordance with some embodiments of the invention, the optical system 100 may employ a unity gain magnification such that the input image is approximately the same size as the image that appears on the light sensitive surface of the CMOS sensor 120.

In accordance with some embodiments of the invention, the optical system 100 is a “contact mode” system in that the scanner is designed to be pressed against the paper that contains the security mark so that an input aperture 106 of the optical system 100 is in the input image plane. Due to the contact of the aperture 106 with the paper, the FOV and focal point of the handheld device are known which minimizes de-focus, blur and other problems that may otherwise be introduced due to the use of a handheld device.

The unity gain magnification also means that it is possible to control the optical gain of the device via the design and manufacturing tolerances, which means that device-to-device variations are minimized. This also improves the robustness of the authentication process to errors as the reference image and subsequent images for authentication are a similar size.

Thus, the input image lies in a plane that is co-located with the aperture 106. More specifically, the input image enters the optical system 100 through an input block 104, where the image passes through a refractive lens 108 and is directed by the lens 108 to a concave surface mirror 130. The image reflects off of the reflective surface of the mirror 130 and returns to the refractive lens 108, which directs the reflected image in an optical path that coincides with the CMOS sensor 120. Thus, the input image is relayed symmetrically through the input block 104, onto the mirror 130 and arrives back in focus in the same plane as the input image. Therefore, in accordance with embodiments of the invention, an exemplary ray 107 may travel from the input image to the refractive lens 108, which produces a corresponding ray 109 that travels to the reflecting surface of the concave mirror 130. The ray 109 reflects off of the reflecting surface and returns as the ray 111 to the refractive lens 108. The refractive lens 108 produces a resulting ray 113, which travels to the mirror 118, which reflects the ray 113 to produce the corresponding ray 119 that is incident on the sensitive surface of the CMOS sensor 120. This symmetry also minimizes chromatic aberration contributing in part to the overall high resolution of the lens.

Due to the symmetrical nature of the optical relay path, the image sensitive plane of the CMOS sensor 120 is the same distance from the reflective surface of the mirror 130, as the plane of the original image except for any minor correction to compensate for any air gap that exists in the sensor 120. As depicted in FIG. 2, in accordance with some embodiments of the invention, a folding mirror 118 may be used to redirect the image from the refractive lens 108 at a ninety degree angle relative to the sensitive surface of the imager 120. This design allows the sensitive surface of the CMOS imager 120 to be moved away from a location that is coplanar with the aperture 106 and thus, be moved inside the scanner.

Due to the aperture 106 being coplanar with the image plane, the input image (i.e., the security mark) is not illuminated, as all ambient light is excluded. Therefore, in accordance with some embodiments of the invention, the optical system 100 includes a prism 117, which directs light from a light source 116 (a light emitting diode (LED) light source, for example) into the optical path of the optical system 100. In combination with the aperture provided by the refractive lens 108 and the optical blocking on the external surfaces of input block 104, this design provides a uniform illumination that is consistent with the dispersion of the source and is free from unwanted internal reflections.

In accordance with some embodiments of the invention, the input block 104 may be formed from a single integrated low cost plastic, which has a molded lens to form the refractive lens 108. An air gap 115 exists between the input block 104 and the reflective surface of the concave mirror 130.

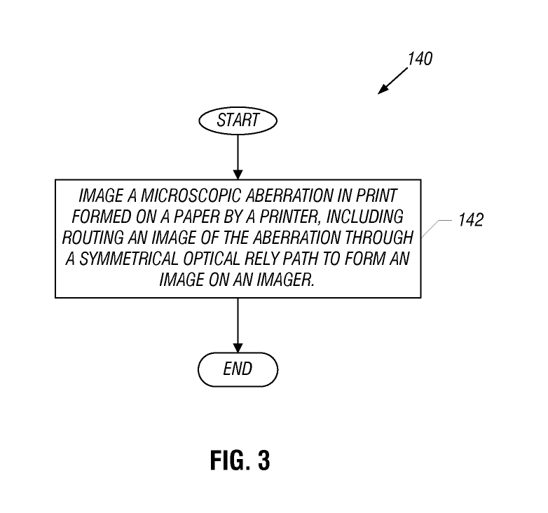

Referring to FIG. 3, to summarize, in accordance with some embodiments of the invention, a technique 140 may be used for purposes of imaging a microscopic aberration in printed matter that is formed on a paper by a printer. The aberration may have a size that is less than the minimum addressable mark size of the printer. The technique 140 includes routing an image of the aberration through a symmetrical optical relay path to form an image on an imager, as depicted in block 142.

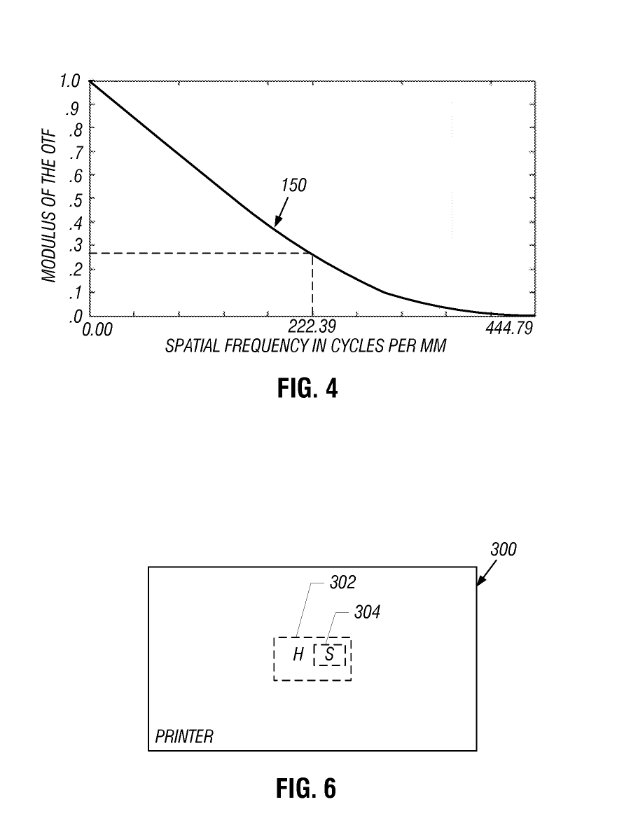

As depicted in FIG. 4, in a test conducted using the optical system 100, a modulus 150 of the optical transfer function (MTF) decayed to a value of 0.26 for a spatial frequency (in cycles per millimeter) of 222.39. This corresponds to a contrast of twenty six percent for a 2.2 micron resolution. Other and different performances may be achieved, in accordance with other embodiments of the invention.

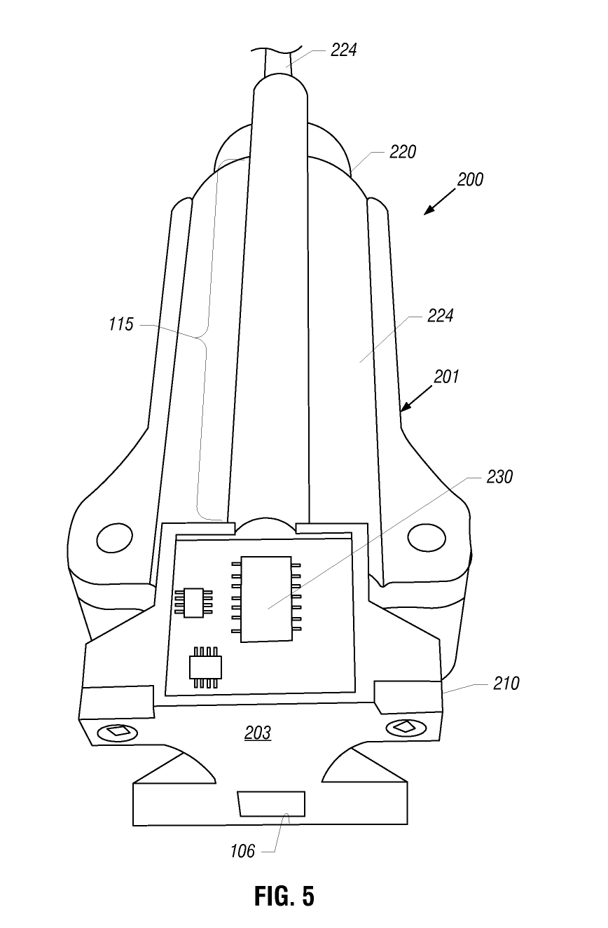

In accordance with some embodiments of the invention, the optical system 100 may be incorporated into a handheld scanner 200 that is depicted in a perspective view in FIG. 5. In general, the handheld scanner 200 includes a body 201 that is configured to be gripped by a person's hand and may be connected to a computer (not shown) by a communication cable 224. Many variations are contemplated. As examples, depending on the particular embodiment of the invention, the scanner 200 may be wirelessly connected to a computer; the scanner 200 may store scanned images for later download to a computer; the scanner 200 may contain circuitry to process the scanned image without the need for a computer connection; the scanner 200 may receive power from batteries; the scanner 200 may receive power via the cable 224; etc.

The body 201 of the scanner 200 includes an input section 210, which contains the input block 104 (i.e., the aperture 106, CMOS imager 120, light source 116, prism 117, folding mirror 118 and refractive lens 108, as depicted in FIG. 2) of the optical system 100. The input section 210 contains a planar face 203 that contains the aperture 106 and is configured to be pressed against the paper that contains the security mark to be imaged. In accordance with embodiments of the invention, the body 201 of the scanner 200 is elongated to establish the air gap 115 between the input block 104 and the concave mirror 130, which is disposed in a section 220 at a distal end of the body 201. Among its other features, the scanner 200 may includes electronics 230 (electronics to control operations of the CMOS imager 120, drive the light source 116, communicate the scanned imager to an external device, etc.) that are disposed in the input block 210.

It is noted that the handheld scanner 201 is one example out of many examples of possible embodiments of scanners that be used to image microscopic features of a security mark.

The scanner may be part of a stationary machine and thus, may not be a handheld device, in accordance with other embodiments of the invention. For example, FIG. 6 depicts a printer 300 that may be used to image microscopic aberrations of a security mark, in accordance with other embodiments of the invention. As a non-limiting example, the printer 300 may include a print head 302 that has an attached optical system 304, which includes a symmetrical optical path relay, such as (for example) the Dyson relay that is described above.

The printer 300 may be used to store an imaged, source security mark so that this stored image may later be used in a comparison to determine whether a scanned security mark is authentic. Therefore, as an example, upon printing a particular label or other document that is to be authenticated, the optical system 304 may produce the reference image that is stored. Later, when the authenticity of the label or document is to be verified, the stored image may be compared with an image obtained by a handheld scanner (as a non-limiting example), such as the scanner 100 that is depicted in FIG. 5.

Other variations are contemplated and are within the scope of the appended claims. For example, in accordance with other embodiments of the invention, a symmetrical optical relay, other than a Dyson relay may be used. In this regard, in accordance with other embodiments of the invention, an Offner symmetrical optical relay may be used in place of the Dyson relay that is depicted in FIG. 2, for purposes of forming an image on the CMOS imager 120. Other variations are contemplated and are within the scope of the appended claims.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

1. A method comprising:
imaging an aberration in print formed on a paper by a printer having an associated minimum addressable mark size, the aberration having a size less than the minimum addressable mark size and the imaging comprises routing an image of the aberration through a symmetrical optical relay path to form an image on an imager.

2. The method of claim 2, wherein the routing comprises magnifying the image of the aberration by a factor substantially near unity to form the image of the imager.

3. The method of claim 2, wherein the routing comprises routing the image through a Dyson or an Offner optical relay.

4. The method of claim 2, wherein the routing comprises forming contacting the paper with an imaging tool.

5. The method of claim 1, further comprising:
illuminating the optical rely path with a light source.

6. An apparatus comprising:
a symmetrical optical relay path to receive a first image of an aberration in print formed on a paper by a printer; and
an imager comprising a light sensitive surface to receive a second image of the aberration from the symmetrical relay path.

7. The apparatus of claim 6, wherein the apparatus comprises:
a handheld unit comprising the symmetrical optical relay path and the imager.

8. The apparatus of claim 6, wherein the symmetrical optical relay path comprises
a reflector to reflect the first image to form the second image.

9. The apparatus of claim 8, further comprising:
a refractive input block to direct the first image to the reflector and direct the second image from the reflector to the imager.

10. The apparatus of claim 9, further comprising:
a folding mirror disposed between the input block and the imager to direct the second imager from the reflector to the imager.

11. The apparatus of claim 9, further comprising:
an air gap;
a first block at one end of the air gap, the first block comprising the refractive input block and the reflector; and
a second block at another end of the air gap, the second block comprising the reflector.

12. The apparatus of claim 8, further comprising:
a light source to illuminate the optical relay path.

13. The apparatus of claim 6, further comprising:
a unit to contain the relay path and the imager and be adapted to be disposed in the printer.

14. A method comprising:
capturing a fingerprint of a printed document, comprising routing an image of a portion of the document formed on a surface of the document through a near unity magnification optical path to a surface of an imager.

15. The method of claim 14, further comprising electrically capturing the image using the imager.

16. The method of claim 14, wherein a feature size of the fingerprint is less than approximately 10 microns.

17. The method of claim 14, wherein the fingerprint comprises a microscopic aberration in an ink output of a printer from an ink dot formed on the printed document by the printer.

18. The method of claim 17, wherein the aberration comprises a tail that diverges from the dot.

19. The method of claim 17, wherein the aberration comprises local variations in a diameter of the dot.

20. The method of claim 14, wherein the capturing comprises illuminating the image with a light source.
